(19) United States
(12) Patent Application Publication
(10) Pub. No.: US 2025/0037687 A1
(43) Pub. Date: Jan. 30, 2025

(54) Rotating Stand for Supporting Stringed Musical Instruments

(71) Applicant: Cole Connelly Jacob Mishler, San Francisco, CA (US)

(72) Inventor: Cole Connelly Jacob Mishler, San Francisco, CA (US)

(21) Appl. No.: 18/226,480

(22) Filed: Jul. 26, 2023

(51) Int. Cl. G10G 5/00; G10D 3/00

(52) U.S. Cl. CPC G10G 5/00; G10D 3/00

(57) ABSTRACT

A stringed instrument stand is rigidly mounted to a musical instrument and is movable from a stowed position into a deployed position to support the musical instrument in an upright position. The stand includes two legs in a rotating assembly that is attached to the lower end face of the stringed instrument through a supporting plate and into the existing strap button mounting holes that are normally found on the bottom face of stringed instruments. The assembly consists of an axle member, two leg members, and a cap member at the bottom thereof and is rotatable between a stowed and deployed position. In the stowed position, the leg members rotate below the flush surface of the stringed instrument back. In the deployed position, the leg members and cap (or existing strap button) form 3 points of contact to support the stringed instrument. The stand is low profile in relation to the musical instrument and does not interfere with the normal operation of the instrument. The securing of the stand is completely reversible and non-invasive or damaging to the stringed instrument.

### REFERENCE TO RELATED PATENTS

U.S. Pat. No. 4,693,161 September 1987 Uhrig.

U.S. Pat. No. 5,197,701 March 1993 Olson.

U.S. Pat. No. 6,130,375 October 2000 Kellogg et al.

U.S. Pat. No. 6,603,067 August 2003 Woolen.

2022/0076649 March 2022 Griffis

### FIELD OF THE INVENTION

The present invention relates to a supporting device for stringed instruments when they are not being played, and more particularly to a securely attached device that provides for quick standing of a stringed instrument, such as a guitar, without needing a separate guitar stand.

### BACKGROUND OF THE INVENTION

Musicians commonly encounter a need for temporary placement and support of their stringed instrument when it is not being played and it is inconvenient to place it in its case. Stringed instruments, such as guitars, may become damaged if simply laid flat on the floor or leaned against nearby objects. Conventional stringed instrument stands are designed to support and hold a musical instrument by placing the instrument on a separate stand. Conventional stringed instrument stands have several deficiencies which make their use both cumbersome and inefficient. For example, these stands must be transported separately from the stringed instrument, and thus they add to the amount of equipment which a musician typically must carry, deploy and store.

Three types of stands which are retained on the musical instrument in a collapsed configuration while the instrument is being played, and which can then be deployed as a stand when the instrument is not in use have been proposed. Each type has its disadvantage as discussed in the following paragraphs.

U.S. Pat. No. 4,693,161 by Uhrig and U.S. Pat. No. 5,197,701 by Olson require specialty hardware or destructive modifications to the musician's stringed instrument to function properly.

U.S. Pat. No 2022/0076649 by Griffis requires an adhesive to hold the device in place. Without the advantage of a mechanical retaining feature, the adhesive has a high-probability of failing under foreseeable misuse, as well as the potential permanent damage long-term adhesive exposure can cause to the finish of a stringed instrument.

U.S. Pat. No. 6,130,375 by Kellogg et al. and U.S. Pat. No. 6,603,067 by Woollen are mechanically complex devices and require a particular stringed instrument shape to function properly. Furthermore, these devices, along with the three previously mentioned, become an intrusive addition to the back of the instrument, causing discomfort to the musician or damage to their clothing. These stands are bulky, complex and expensive, encouraging musicians to continue using the separate stands or risking damage to the stringed instrument by leaning it up against another object or wall.

### DESCRIPTION

At least one specification heading is required. Please delete this heading section if it is not applicable to your application. For more information regarding the headings of the specification, please see MPEP 608.01 (a).

### SUMMARY OF THE INVENTION

The present invention pertains to a stand for supporting a stringed musical instrument, such as a guitar, in an upright position when the instrument is not being played. The stand remains attached to the instrument, in a non-intrusive way, when it is being played. The stand includes two legs, in a rotating assembly that is attached to the lower end face through a supporting plate and into the existing strap button mounting holes, which engage a supporting face, such as a floor or tabletop. The two legs and existing strap button or cap create three points of contact with the supporting face to define a plane for supporting the instrument in the upright position.

The rotating assembly is pivotally connected to the instrument to permit it to be rotated between a stowed position where the legs are beneath the instrument, and a second position, rotated behind the instrument where the legs and the existing strap button or cap form a tripod-like support. While stowed, the stand is positioned so not to interfere with the instrument being played.

It is therefore an object of the present invention to provide a support stand which is attached to a stringed musical instrument, such as a guitar, for supporting the instrument in an upright position when the instrument is not in use.

### BRIEF DESCRIPTION OF DRAWINGS

FIG. 1 is the perspective view of the stand in its stowed position while mounted on a stringed instrument.

FIG. 2 is the perspective view of the stand in its deployed position while mounted on a stringed instrument.

FIG. 3 is the perspective view of the stand in its deployed position while mounted on a stringed instrument and sitting in a stable, upright position while engaging a supporting face, such as a floor or a tabletop.

FIG. 4 is an exploded view of the stand of the present invention isolated from the stringed instrument.

FIG. 5 is an exploded view of the stand of the present invention attached to the stringed instrument.

### DETAILED DESCRIPTION OF THE INVENTION

Detailed descriptions of the preferred embodiment are provided below. It is to be understood that specific details disclosed are not to be interpreted as limiting, but rather a basis for the claims and as a representative basis for teaching one skilled in the art to employ the present invention in virtually any appropriately detailed system, structure or manner.

FIG. 1 shows the bottom of a guitar body 1 with the stand assembly in the stowed position. The strap button 13 and screw 14 secure the entire rotating assembly on the bottom face of the stringed instrument body 1. This strap button 13 and screw 14 are found on virtually all stringed instruments. It is a common fastening point and is structurally sound since it is designed to undergo the stresses of a musician putting pressure on the stringed instrument, as well as the weight of the stringed instrument itself. Additionally, since this attachment point already exists, there is no need to drill or create any other destructive, non-reversible modifications to the instrument, which would decrease its value. L bracket 2 contacts the body 1 first, followed by base piece 4, rotating arms 8 and 10, cap 12, and secured by strap button 13 and screw 14.

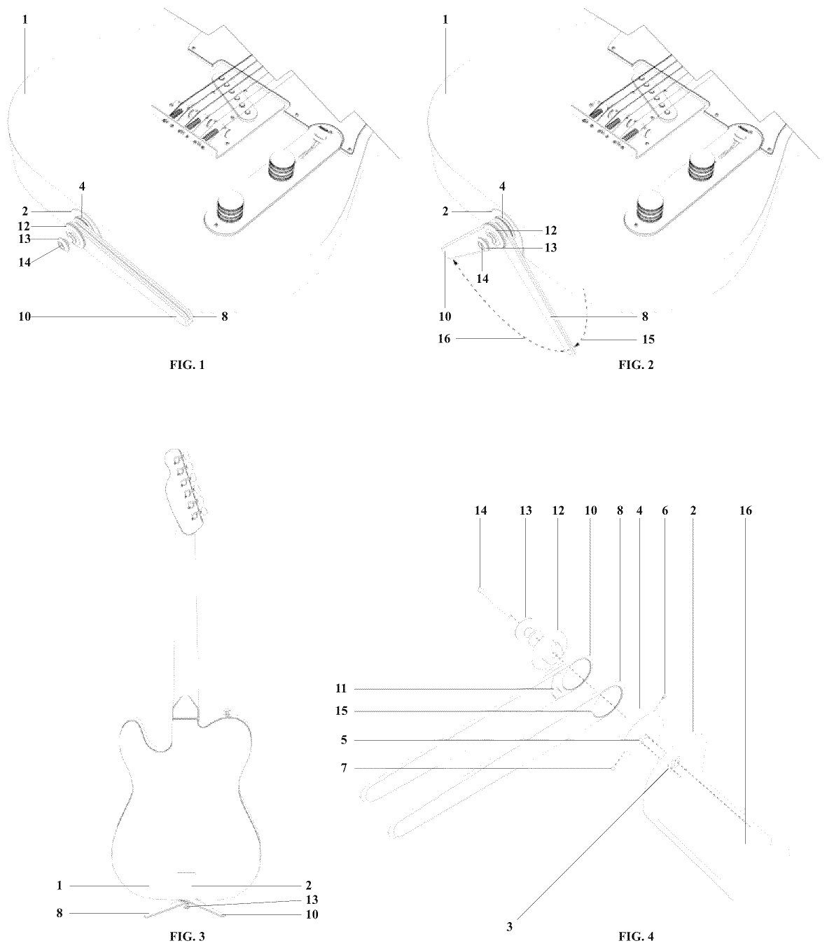

FIG. 2 shows the bottom of a guitar body 1 with the stand assembly in the deployed position. The rotating arm 10 is rotated into the deployed position 16 and clicks into a detent feature. Because the arms are interlocked, rotating arm 8 is pulled into the deployed position 15 at the same time and clicks into its corresponding detent feature. Having this distinct deployed position with detents creates a more stable assembly in the deployed position and ensures that the rotating legs 8 and 10 are spaced accordingly to prevent the stringed instrument from tipping over once the stand has been deployed.

FIG. 3 shows the bottom of a guitar body 1 with the stand assembly in the deployed position and sitting in the upright, supported position on a supporting plane, such as the floor or a tabletop. This image details how the supporting legs 8 and 10, along with the existing strap button 12, create 3 points of stable contact with a supporting plane once the assembly is in the deployed position.

While the invention has been described in connection with a preferred embodiment, it is not intended to limit the scope of the invention in the form set forth, but on the contrary, it is intended to cover such alternatives, modifications, and equivalents as may be included within the spirit and scope of the invention.

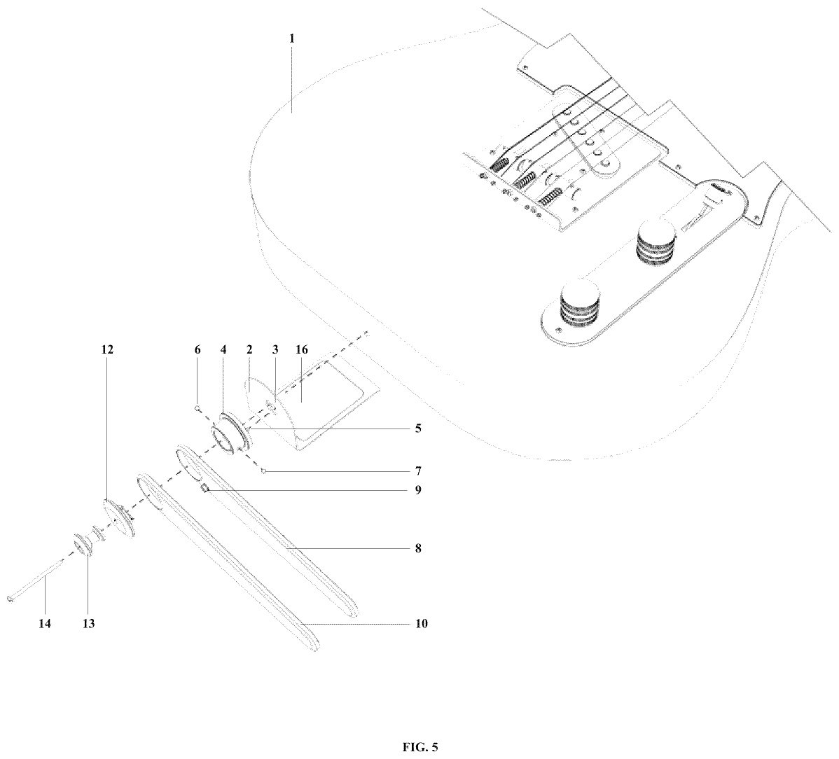

FIGS. 4 & 5 shows the bottom of a guitar body 1 with an exploded view of the stand assembly. This demonstrates the simplicity of the system and few number of moving parts, intending to prevent a malfunction and keep production costs low. The L bracket 2 contacts the body 1 first by way of a rubberized or felted pad 16 and gains added structure by touching off the back of the stringed instrument and transferring stress from the screw 14 to the entire L bracket 2. The base 4 is attached and prevented from rotating by inserting alignment pin 5 into the alignment hole 3. This image also details the location of the detents 6 and 7 mentioned in the previous paragraph which are pressed into the base 4 and create two distinct positions with the detent hole 15 on rotating leg 8. Rotating leg 8, which includes a large bore, is then pressed onto base 4, followed by rotating leg 10, so that each leg can rotate therearound. The rotating legs 8 and 10 are aligned by inserting rotation pin 9 into arcuate slot 11, a feature on the backside of rotating leg 10. The cap 12 is then inserted, followed by the existing strap button 13 and screw 14, securing the entire assembly to the bottom of the guitar body 1.

The invention claimed is:

1. Support arrangement for a stringed instrument with a support being pivotally attached by a non-invasive and reversible attachment means to the bottom of the stringed instrument which can be rotationally pivoted away from the instrument when the instrument is in the standing position, characterized in that the support with its attachment means are integral with the body, such that there are no protruding parts when the support is in the stowed position.

2. Support arrangement according to claim 1, characterized in that a strap button or other non-intrusive hole is provided at the bottom of the instrument.

3. Support arrangement according to claim 1, characterized in that the support utilizes rotational legs to create a triangular support plane with the existing strap button.
